(19) United States
(12) Patent Application Publication
(10) Pub. No.: US 2008/0162211 A1
(43) Pub. Date: Jul. 3, 2008

(54) System and Method For Buying and Selling Event Tickets

(76) Inventor: Don W. Addington, Fort Worth, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/911,640

(22) PCT Filed: May 9, 2006
(86) PCT No.: PCT/US2006/017868

§ 371 Date: Oct. 15, 2007

Related U.S. Application Data
(60) Provisional application No. 60/678,962, filed on May 9, 2005.

(51) Int. Cl. G06Q 30/00

(52) U.S. Cl. 705/7; 705/37

(57) ABSTRACT

A system and method are provided for facilitating the buying and selling of event tickets. The system and method disclosed herein includes a system and method for valuing and selling unsold tickets shortly before and/or during the event. Embodiments disclosed herein allow users to interact with a ticket trading system via telephone or internet in order to search for tickets available for sale. The disclosed system and method can incrementally adjust the prices of the available tickets according to one or more demand variables having values that reflect various demand indicators. The values of the demand variables can be established based on demand indicators evaluated shortly before and/or during the event.

### TECHNICAL FIELD

The present invention relates generally to a system and method for facilitating the buying and selling of event tickets. More specifically, the present invention relates to a computer-implemented system and method for facilitating the buying and selling of event tickets that involves automatic price adjustment.

### DESCRIPTION OF THE PRIOR ART

The event ticket industry includes numerous types of events such as sports events, music concerts, theater, and family entertainment. Each event is marketed to the general public well in advance (months) of the actual calendar date and starting time of the event. Tickets are sold to each event through various channels that include the Internet, telephone sales, and physical ticket locations.

In addition, ticket sales occur in two types of markets. The first is a primary market—tickets sold directly from event managers to ticket buyers or from event managers via an authorized ticket distributor. Examples of authorized primary market ticket distributors are Ticketmaster, Tickets.com, and Paciolan.

The second type of market is the secondary market. In the secondary market, original ticket buyers re-sell their tickets to other interested ticket buyers (third parties). Like original ticket buyers, these third party buyers can be individual consumers, corporate consumers, or ticket brokers. There are many legitimate ticket brokers specifically in business to earn revenue through buying and selling tickets in the secondary market. They provide liquidity to the market for high demand tickets and often re-sell tickets above face value.

Ticket demand for a given event can vary greatly. When primary market ticket demand is low or less-than-high, event managers have unsold tickets near the start time of the event as well as after the event begins.

Fixed pricing structures for event tickets are inefficient for events where demand is low or less-than-high. In other words, there currently is no organized method to stimulate demand for unsold tickets near event start time—the time after which all other channels for selling tickets has been tried and exhausted.

This problem typically does not exist for high demand events. High demand events have demand-well in advance of event start time—that exceeds ticket supply. However, an example of an exception to this statement are high demand event tickets that have undesirable attributes, such as: (a) a few unsold tickets that are non-contiguous in seat location (thereby disqualifying a group of 2 or more persons that want to sit together), or (b) tickets for seats located in an inferior seating location (e.g., view of the event is partially blocked by a building column).

Event managers (those marketing the event) cannot easily reduce their ticket prices in an attempt to increase demand in an oversupply situation or for tickets with undesirable attributes. Doing so creates a risk that future demand patterns are negatively affected—consumers with higher interest in the event that hear of discounted tickets from a previous event may expect discounts in upcoming events and therefore avoid paying face value in advance. This could thereby affect long run revenue for the event manager. As a result, event manager revenue is not maximized for events where demand is “low” or “less-than-high”. Also, consumers willing to consume an unsold ticket to a “low” or “less-than-high” demand event do not consume due to face value ticket prices that are too high for that given event.

### SUMMARY OF THE INVENTION

According to one aspect of the present invention, a system and method is provided to help drive the sale of unsold tickets, particularly for low and less-than-high demand events. Embodiments of the disclosed system and method can also be directed towards helping to drive the sale of unsold tickets without attracting sale of event tickets to consumers that already intend to purchase through conventional methods of ticket distribution.

According to another aspect of the present invention, a system and method is provided for facilitating the buying and selling of event tickets very near (e.g., within 2 to 4 hours) the starting time of each individual event as well as during the event.

According to another aspect of the present invention, a system and method is provided for adjusting the price of event tickets. According to a preferred embodiment, the ticket price for an unsold ticket is decreased until that value reaches a predetermined minimum monetary value, or the event ends, whichever comes first. The rate of decrease can vary depending on one or more of a number of factors. A preferred embodiment includes a computer-implemented system that uses an algorithm for measuring the rate of demand for the unsold event ticket in comparison to the theoretical time remaining in the event ticket's useful life, and adjusts the “asking price” for the unsold ticket downward in increments.

For example, if the rate of demand or event time remaining—or both—are high, the asking price remains relatively stable. However, as the rate of demand begins to decline and as useful life remaining declines, the asking price adjusts downward until rate of demand increases to a new point of price stability. This process continues until demand reaches a predetermined minimum (e.g., zero or 10% of face value or 50% of face value) or the useful life an event ticket is too small for sale (e.g., because the event has ended or is near ending).

Some embodiments of the present invention can add value to the industry by creating a new sales channel specifically designed for events with low or less-than-high demand and/or for the period near the start of an event. Further, embodiments of the present invention can increase consumer welfare and event manager revenue by helping correct pricing inefficiency for low and less-than-high demand events.

These and other advantages and features of the present invention will become readily apparent to those skilled in the art upon examination of the subsequent detailed description and accompanying drawings. Accordingly, additional advantages and features of the present invention and the scope thereof are pointed out with particularity in the claims and form a part hereof.

### BRIEF DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 shows a block diagram of a preferred embodiment of a trading system according to the present invention;

FIGS. 2A and 2B show a flowchart illustrating a trading process that can be performed by the trading system;

FIG. 3 shows a flowchart illustrating a pricing algorithm and process that can be performed by the trading system; and

FIG. 4 shows a graph illustrating possible variations in ticket pricing over time according to the preferred algorithm.

### DESCRIPTION OF THE PREFERRED EMBODIMENT

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

### Trading System

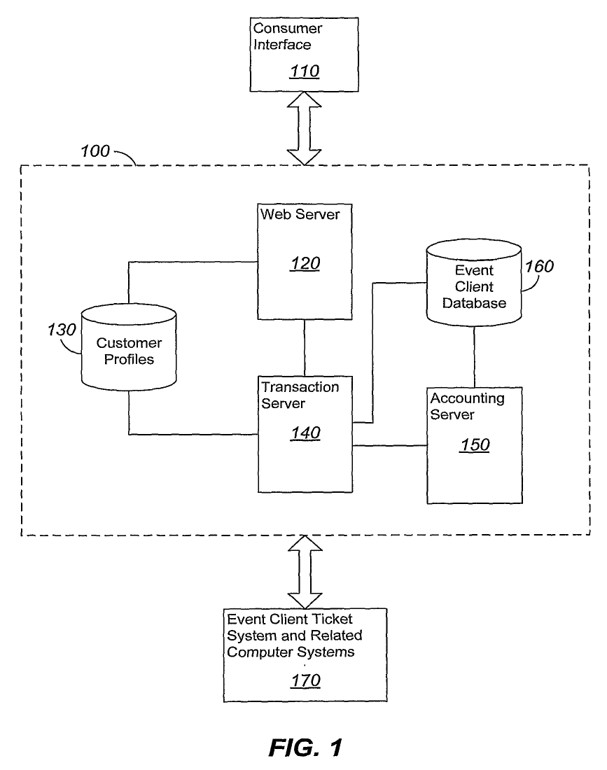

FIG. 1 shows a block diagram of a preferred embodiment of a trading system 100 according to the present invention. The trading system 100 shown in FIG. 1 includes a number of components for performing tasks described herein below; however, it should be appreciated that the division of tasks can be implemented in a variety of ways without departing from the spirit and scope of the present invention. For example, the trading system 100 can include any number of actual computers and/or servers; in some embodiments the trading system 100 can include all of the components 120-160 on a single computer or server, while in other embodiments combinations of the components 120-160 can be implemented on one or more computers or servers. Also, any of the components 120-160 can be implemented on a single computer or server or, alternatively, can be spread among a plurality of servers or computers. Thus, architectures other than the exact architecture shown in FIG. 1 can be used without departing from the spirit and scope of the present invention.

The trading system 100 can be accessed by potential buyers using a consumer interface 110. While only a single consumer interface 110 is illustrated, any number of consumer interfaces 110 can access the trading system 100. The consumer interface 110 can be an electronic device, for example a computer, a telephone (mobile or land-line), a Personal Digital Assistant (PDA), or a television (e.g., via an interactive on-screen interface). Communication between the consumer interface 110 and the trading system can include wired and/or wireless communications. Any of a number of communications protocols and methods can be used to implement communication between the consumer interface 110 and the trading system 100. For example, communication between the consumer interface 110 and the trading system 100 can include transfer of data over a computer network, which can include the Internet, using any suitable network protocol. Communication between the consumer interface 110 and the trading system 100 can include the use of an interactive voice system. For example, the consumer interface 110 can be a telephone that communicates with the trading system 100 via an interactive voice system that uses voice-recognition software to recognize voice commands received from the telephone and transfer corresponding data to the trading system 100.

In the preferred embodiment illustrated in FIG. 1, the trading system 100 includes a web server 120 for communicating with the consumer interface 110 via the Internet. The web server 120 can include any number of computer servers configured to communicate with the consumer interface 110 via the World Wide Web. The web server 120 can include software for generating a web page including a graphical user interface at the consumer interface 110. The web server 120 can provide information to a user at the consumer interface 110 and receive information from the user at the consumer interface 110. For example, the web server 120 can provide information regarding available tickets and ticket prices to the user at the consumer interface 110. The user can then use the consumer interface 110 to send information to the web server 120 regarding a desire to purchase tickets. Further details concerning the types of information exchanged between the web server 120 and the consumer interface 110 are discussed below.

The trading system 100 also includes a profiles database 130 for storing information regarding consumer profiles. The profiles database 130 is in communication with the web server 120. The profiles database 130 can be implemented in any of a number of ways without departing from the spirit and scope of the present invention. For example, the profiles database 130 can reside on a database server that is in communication with the web server 120. Alternatively, the profiles database 130 can be a database that resides on the same computer as the web server 120.

In a preferred embodiment, the trading system 100 allows users to register and set up an account with the trading system 100. The process for setting up an account preferably includes receiving information at the web server 120 from the consumer interface 110 for establishing a customer profile associated with the user. The web server 120 can store the received information in the profiles database 130. Also, when a user with an existing account attempts to access the trading system 100, the web server 120 can retrieve information about the user's account from the profiles database 130.

The customer profile can include information such as user name and password for logging in to the trading system, as well as personal information such as name and address of the user. The customer profile can also include preference data. For example, the preference data can include information about preferred types of events, preferred teams, and/or preferred venues. The preference data can also include preference information for receiving alerts from the trading system 100. For example, the preference information can include instructions for sending an alert at a specified amount of time before an event starts, for sending an alert if there are any tickets available, and for sending an alert if a discount reaches a specified level or percentage. Other profile and preference information can be included without departing from the spirit and scope of the present invention.

The trading system 100 also includes a transaction server 140, an accounting server 150, and an event client database 160. The transaction sever 140 can perform a variety of tasks related to processing a ticket-purchase transaction. The transaction server 140 can include a pricing engine for calculating ticket trading prices according to algorithms discussed below. The transaction server 140 can also include a transaction engine for processing ticket purchases. According to a preferred embodiment, the transaction server 140 is a computer and the pricing and transaction engines are implemented as software modules. The transaction server 140 can also be in communication with third parties that can assist in processing transactions. For example, the transaction server 140 can be in communication with a credit card company clearing system (not shown) for assisting in processing credit card payments for ticket purchases.

Tasks performed by the transaction server 140 can include, but are not limited to: (a) communicating with accounting server 150 and (b) logging into accounting server data for specific fields of numerical or text attributes of a ticket purchase or ticket purchases that: (1) are relevant to accurately account for accounts payable (to Event Clients) and/or accounts receivables (from Event Clients), (2) are desirable for tracking in high detail other accounting data such as sales, commissions, required fees, and other charges associated with ticket sales through said invention, (3) are desirable for successful completion of processing of credit card charges associated with ticket sales through the trading system 100.

The trading system 100 is preferably accessible to Event Client ticket systems and/or other related ticket client computer systems 170 (e.g., event client accounting systems) operated by an event client (e.g., event manager or other entity responsible for selling tickets to an event). In a preferred embodiment, the event client ticket system 170 includes a computer system that is in communication with the trading system 100 via the internet. In some embodiments, the Event Client can be an event manager or authorized ticket distributor, and the trading system 100 can serve as a conduit for primary-market ticket sales. Interaction between Event Client ticket system 170 and accounting server 150 and transaction server 140 can include, but is not limited to: (1) logging relevant, accurate accounting-based information to Event Client system 170 from ticket sale transactions; for example, final sale price of tickets and associated commissions earned by inventor from said sale, volume of tickets sold with specific event identification data, and (2) Event Client ticket system 170 logging updated data into transaction server 140 associated with allocation of tickets to be sold.

The Event Client system and/or other related ticket client computer systems 170 can also include systems for providing data about an event while the event is in progress, and the trading system can use information included in such data for calculating and/or adjusting ticket event prices. For example, if the event is a sporting event, the systems 170 can provide data representative of game statistics (e.g., for baseball: inning, score, runs, hits, homeruns, errors; for football: quarter, score, touchdowns, running yard, passing yards). The system 170 can be configured to alert the trading system 170 to special circumstances that can have an impact on ticket demand during the event. For example, the system 170 can be configured to alert the trading system 100 to the potential for a no-hitter in baseball, a potential for a record to be set in a sporting event, or other such special circumstances. Where the event is a sporting event, the system 170 can be configured to provide information about player injuries shortly before and/or during an event, particularly where such information can be expected to impact demand for event tickets shortly before or during an event.

### Trading Process

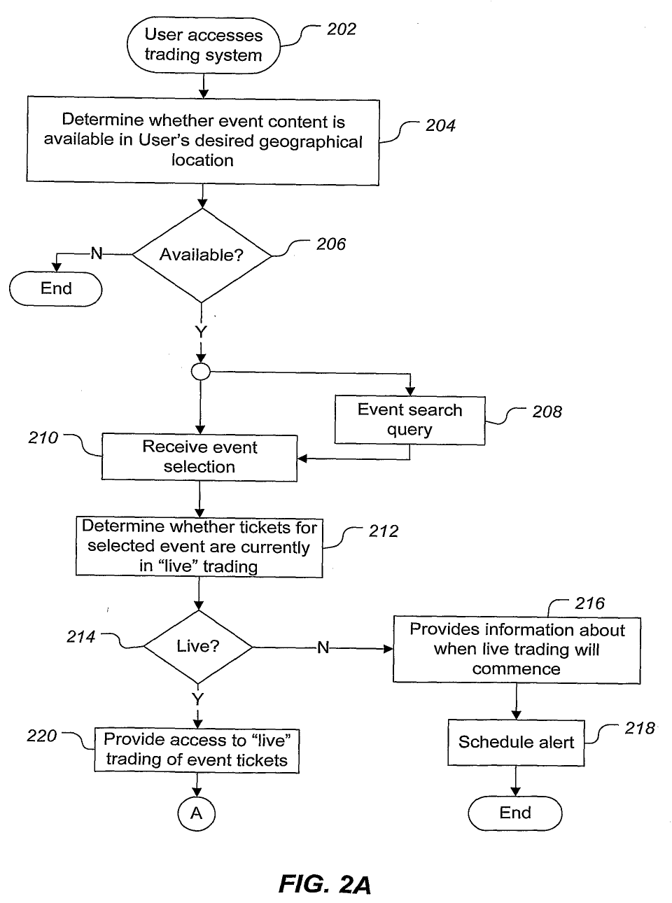

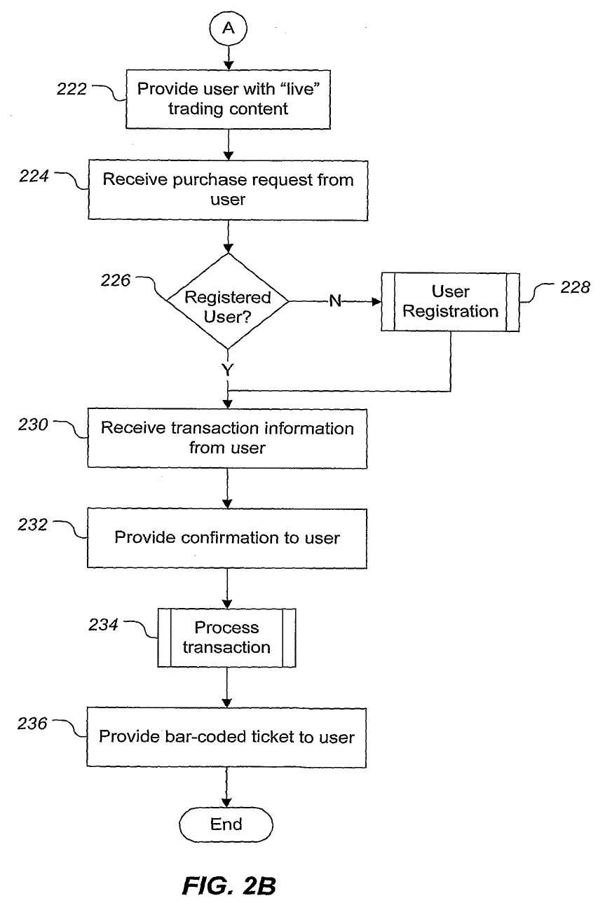

FIGS. 2A and 2B show a flowchart illustrating a trading process that can be performed by the trading system 100. The trading process shown in FIGS. 2A and 2B is equally applicable to alternative embodiments of the trading system 100. The trading process begins at step 202 with a user accessing the trading system 100. In a preferred embodiment, the user proceeds to a website address of the trading system 100 using an Internet browser on a computer or other electronic device capable of accessing the Internet (e.g., mobile telephone or PDA).

At step 204, the determination is made as to whether there is any event content available for the user's desired geographical location. This step can include querying the user to determine the user's desired geographical location. Alternatively, or in addition to performing such a query, the trading system 100 can attempt to determine the user's geographical location. For example, if the user is a previous visitor to the website, the trading system 100 can be configured to recognize the user (e.g., through the use of an HTTP cookie or profile information) and recall the user's previously-entered geographical preferences. Alternative methods of geolocation are contemplated, for example based on the user's IP address. Once the trading system 100 has attempted to establish a geographical location for the user, the trading system 100 searches the event client database 160 for event content that is available for the user's geographical location.

At step 206, the trading process ends if the system finds no available event content for the user's geographical location. Alternatively, the system can prompt the user to try a different geographical location, in which case the trading process would return to step 204.

If, at step 206, the system has found event content for the user's geographical location, then the trading process can proceed to either step 208 or step 210. For example, in some embodiments, the web server 120 generates a web page at the consumer interface 110 that includes a list of available events and/or a means for initiating a search of available events. Alternative methods of allowing the user to view and/or search available events can be implemented without departing from the spirit and scope of the present invention. For example, a tabbed browsing feature can be implemented that allows the user to select from a plurality of category tabs, each category tab corresponding to an category of events (e.g., sports, music, special events), and view and/or search available events associated with the selected category tab.

At step 210, the trading system 100 receives a selection from the user of an event of interest. For example, the user can indicate to the trading system 100 that a particular event is an “event of interest” to the user by selecting the event from a list of available events or from a list of search results (e.g., generated at step 208).

At step 212, the trading system 100 determines whether tickets for the selected event of interest are currently in “live” trading such that they are available for purchase. In some embodiments, the trading system 100 can be configured to allow purchase of tickets to an event only shortly before the event and/or during the event. In embodiments where the trading system 100 restricts ticket sales to a period of time that begins shortly before the beginning of the event and continues during the event, the trading system can prohibit sale of the event tickets until a predetermined period of time until the event is expected to begin. In some embodiments, the predetermined period of time is less than the amount of time that the tickets are available from other ticket sources. Thus, the trading system 100 can be configured to allow tickets for an event to be purchased only when the event is scheduled to begin within a predetermined number of days (e.g., 7 days, 5 days, 3 days, one day), hours (e.g., seventy-two hours, forty-eight hours, twenty-four hours, twelve hours, six hours, four hours, two hours, one hour) or minutes (e.g., 60 minutes, 45 minutes, 30 minutes, 15 minutes) even though tickets for the event could have been obtained much earlier (e.g., days, weeks, or months in advance) from another ticket source (e.g., venue ticket office or third party such as Ticketmaster). In some embodiments, the tickets can continue to be in live trading during the event. The live trading can continue until a predetermined amount of time after the event begins or is expected to begin, until a predetermined amount of time before the event is expected to end, and/or until the event is expected to end or actually ends.

Thus, at step 214 the trading system 100 determines whether tickets for the event of interest are presently in live trading. If not, the trading process proceeds to step 216 where the trading system 100 can provide the user with information about the event and an assessment about when live trading may begin for the selected event. At this point, the process can end and the user can return at a later time when the tickets are expected to be available for purchase.

Alternatively, an optional step 218 can allow the user to schedule an alert. The trading system 100 can prompt the user to provide contact information (e.g., email address, telephone number, or pager number) that can be used to alert the user when tickets are available for purchase. Alternatively, the trading system 100 can be configured to allow users to establish different or more complex rules for issuing alerts. For example, the trading system 100 can be configured to allow a user to set up an alert such that the user is only alerted if the ticket price is at or below a certain amount or only if the ticket price is discounted at or above a certain amount. For example, a user can instruct the trading system 100 to issue an alert only if and when tickets for the event are available at 90% of face value regardless of when this condition is satisfied; or, a user can instruct the trading system 100 to issue an alert only if and when tickets for the event are available at 90% of face value and at least 15 minutes remain before the event is scheduled to begin. Alternative or additional conditions for an alert can be implemented without departing from the spirit and scope of the present invention.

Returning back now to step 214, where the trading system 214 makes a determination as to whether tickets for the selected event are available for live trading, if the tickets are “live,” the trading process continues to step 220. At step 220, in a preferred embodiment the trading system 100 provides the user access to a web page that allows the user to view and participate in live trading and/or purchasing of tickets for the selected event. In a preferred embodiment, this step can include a verification process to prevent abuse of the trading system, for example through the use of third-party automated programs. The verification process can include text verification, where the user is presented with an image containing text that cannot be read by an automated program and the user is asked to enter the text in order to proceed to live trading. Alternative verification methods can be used without departing from the spirit and scope of the present invention.

At step 222 the trading system 100 provides the user with access to live trading. In a preferred embodiment, the web server 120 provides the user with a web page that includes trading information about tickets for the selected event. The trading information preferably includes an amount of time remaining until the event is scheduled to begin or an amount of time remaining until the event is expected to end. The trading information can also include information about the tickets, for example a number of available tickets, the location of the seats associated with the available tickets, and the current trading price of the available tickets. The trading information can also include an indication of a limited amount of time during which the price is guaranteed, beyond which the price is subject to change. According to a preferred embodiment, the price of the tickets is subject to change periodically during the live trading according to a number of factors discussed in more detail below.

At step 224, the trading system 100 receives an indication from the user that the user wants to make a purchase of some available tickets. In a preferred embodiment, the trading system 100 requires the user to establish an account by registering with the trading system 100. At step 226, the trading system 100 determines whether the user is a registered user of the trading system 100, for example by prompting the user to log in. Alternatively, the trading system 100 can provide the user with an option to skip the registration process and proceed to check-out.

At step 228 an unregistered user can establish an account. As discussed above, the process for setting up an account preferably includes receiving information at the web server 120 from the consumer interface 110 for establishing a customer profile associated with the user. The customer profile can include information such as user name and password for logging in to the trading system, as well as personal information such as name and address of the user and preferences such as preferred types of events, preferred teams, and/or preferred venues. Other profile and preference information can be included without departing from the spirit and scope of the present invention.

At step 230, the trading system 100 prompts the user to provide transaction information. In a preferred embodiment, the transaction information includes payment and billing information such as a credit card number, expiration date, billing address, and telephone number. Thus, it is preferred that the web server 120 establishes a secure connection with the consumer interface 110, e.g., using a security protocol such as Secure Sockets Layer (SSL) or Secure HyperText Transfer Protocol (S-HTTP). This step can also include the use of a third-party service for sending and receiving payments (e.g., PayPal.com). This step can also include providing a summary of the transaction information and ticket information to the user so that the user can make a final confirmation before finalizing the purchase.

At step 232, the trading system 100 provides the user with a confirmation page, which can include a summary of the transaction and an indication that the transaction is complete. The confirmation page can also include information concerning the method in which the purchased tickets will be provided to the user. For example, in a preferred embodiment the tickets are provided to the user as electronic tickets (“e-tickets”) and the confirmation page includes a notification that the purchased tickets will be provided to the user via email. Alternatively, the confirmation page can include a link that the user can follow to download the e-tickets.

At step 234, the transaction server 140 receives the transaction information obtained from the user at step 230. The transaction server 140 and accounting server 150 perform processing such as communicating with third-party credit card processors for verification. If the credit card is successfully verified, the trading system 100 can provide the user with a confirmation that the payment has been successfully processed. Otherwise, if the credit card verification fails, the trading system 100 can notify the user and request that the user re-enter the billing information or try a different credit card. If the transaction is successful, the accounting server 150 updates ticket inventory in the event client database 160 to reflect the purchase. There are other accounting and transactional tasks that can be included in the processing of the ticket transaction without departing from the spirit and scope of the present invention. Examples of such tasks can include, but are not limited to, transaction server communicating with accounting server and logging into accounting server data for specific fields of numerical or text attributes of a ticket purchase or ticket purchases that: (1) are relevant to accurately account for accounts payable (to Event Clients) and/or accounts receivables (from Event Clients), (2) are desirable for tracking in high detail other accounting data such as sales, commissions, required fees, and other charges associated with ticket sales through said invention, (3) are desirable for successful completion of processing of credit card charges associated with ticket sales through said invention.

Finally, at step 236 the purchased tickets are provided to the user, or at least delivered according to the user's instructions. As mentioned above, in a preferred embodiment the tickets are provided to the user as electronic tickets (“e-tickets”). For example, the web server 120 can generate a web page that includes the e-ticket at the consumer interface 110. Alternatively, the trading system 100 can deliver e-tickets to the user via email or other electronic transfer means (e.g., multimedia messaging). In a preferred embodiment, each e-ticket includes a unique identifier that can be used by venue staff to confirm the authenticity of the ticket. For example, each e-ticket can include a unique bar code that can be scanned to verify the authenticity of the e-ticket. Alternative forms of tickets and ticket delivery can be used without departing from the spirit and scope of the present invention. For example, the trading system 100 can provide the option of allowing the user to pick up the tickets, e.g., at Will Call or other location.

The trading process can be configured to operate according to a number of exemplary rules. For example, tickets for an event are not available for purchase until a predetermined amount of time before the event is expected to begin. Also, tickets for an event can continue to be available for purchase during the event and as long as the event has not officially ended, or, as long as the event is not near (e.g., within a predetermined amount of time) its official ending. For example, in a time-based sporting event, zero time remaining in the game has not been reached; the time remaining here is defined by (a) the official playing time of the game, or (b) in the case of an “overtime” condition, the point at which the overtime is officially ended with no remaining playing time. In the case of events whose endings are not governed by official time increments (such as the sport of Baseball or such as a music concert), the end of the event is the point at which either the rules of the event define its ending (such as the final out in baseball whether in regular innings or extra innings) or the event's approximate ending is apparent based on some condition (such as the announcement of a final song in a music concert). In conditions where the ending is not apparent, the end of the event can be deemed to have been reached by the time a predetermined amount of time (e.g., 24 hours, or even longer for longer events such as golf or cricket) has passed since the official beginning of the event.

### Trading Process

### Alternative Embodiment

Alternative trading processes can be used for embodiments where voice access is used by a user to interact with the trading system 100, for example in embodiments where the consumer interface 110 is a telephone or the like. Also note that in voice-access embodiments, the web server 120 can include or be replaced with a voice server 120. The description of the trading process discussed can apply equally to voice-access embodiments, so only notable differences will be discussed here.

At step 202, the user can access the trading system 110 at step 202 by dialing a telephone number associated with a voice server 120 of the trading system 100. The voice server 120 includes voice interactive software capable of speech and/or telephone touch-tone recognition (e.g., DTMF detector). The voice server 120 provides the user with a welcome message and a menu list of options. The options can include registering for the service, booking tickets, and hearing about events in the user's area. The user can then press a key or speak a word or phrase to advance to the desired option. For example, the user may be instructed to press “2” or say “book tickets” for the booking tickets option.

Once the user has advanced to the booking tickets option, the voice server 120 prompts the user to provide information about the user or about the event of interest. For example, the voice server can ask the user a series of questions such as the name of the event, the number of tickets desired, and the quality of the tickets desired (e.g., best available, cheapest face value, specific price range). Alternatively, as in step 204, the voice server 120 can prompt the user to provide a geographical location of the event of interest (e.g., zip code or name of city). At step 206, the trading system 100 searches the event client database 160 for events that match the information provided by the user, which can also include determining whether the tickets for the event are in live trading (steps 212 and 214). At step 222, the voice server 120 then replies to the user with a spoken results list explaining available seats matching as closely as possible to the information provided by the user. The voice server 120 can also provide alternative options (“For only $2.00 per ticket more, you can move over to section B which is on the 40 yard line”). In addition, an indication of the savings associated with the current price of the tickets (based on results of the pricing algorithm) can be provided to inform the user of the amount of available savings.

The voice server 120 instructs the user to select from the list of available ticket options. At step 224, the user can select from the available ticket options by pressing an appropriate number or saying a number or phrase associated with the desired ticket option. The voice server 120 can also provide the user with the option of changing the ticket request information, for example to change to a different event or to change the number of tickets or ticket quality. Other options can be offered to the user, such as an option to start over completely or to terminate the telephone call.

At this point, steps 226 and 228 can optionally be performed to determine whether the user is a registered user and, if not, prompt the user to establish an account with the trading system 100. The user can also be given the option of setting up an account or skipping the registration process and proceeding directly to check-out.

At step 230, the voice server 120 prompts the user to provide transaction information, including billing information such as a credit card number, expiration date, billing address, and telephone number. The user can be given the option to set up and store the billing information in a membership profile. Then, at step 234 the credit card verification process is performed and, if successful, the voice server 120 replies to the user with a message indicating that the transaction has been successfully completed. Otherwise, the user can be prompted to re-enter the billing information or try a different credit card.

Ticket delivery in the voice-access embodiments can include instructing the user to pick up tickets at Will Call. Alternatively, the trading system 100 can be configured to receive an email address that can be used to email the tickets in electronic form to the user.

### Pricing Algorithm

Additional rules are preferably used to govern the asking price of the tickets. For example, the trading and the respective asking price to a purchaser for the event ticket can be based on a computer-implemented pricing algorithm that measures a number of demand variables. In some embodiments, the pricing algorithm can be such that the price of a ticket can decrease but cannot increase. In such embodiments, the pricing algorithm decreases the asking price as time passes before and/or during the event's life and/or as demand wanes. In some embodiments, the pricing algorithm can adjust ticket prices up and/or down to account for increases and/or decreases in demand for event tickets before and/or during the event. For example, demand for tickets during the course of a baseball game may be expected to decrease as the game progresses. However, unusual or exceptional circumstances, such as a no-hitter during late innings of a baseball game, may result in an increase in demand for tickets. As another example, in some embodiments one or more of the demand variables can be used to adjust the price of tickets to an event during a period of time that begins and ends before the beginning of the event. In other embodiments, one or more of the demand variables can be used to adjust the price of tickets to an event during a period of time that begins before the beginning of the event and ends after the event has begun. In still other embodiments, one or more of the demand variables can be used to adjust the price of tickets to an event during a period of time that begins and ends after the event has begun.

Demand for tickets to a given event is dependent on a number of factors including:
Amount of money spent on advertising (with appropriate lead time) the event;
The public's level of interest in that particular event driven by factors such as the success of a sports team or the popularity of a musician or band;
An impact on the content of the event such as an injury to a popular player on a sports team;
The face value price of tickets to the event;
The number, type and quality of events in the same geographical area (other events that can be considered competing or substitutionary events);
For outdoor events and to some extent, indoor events: weather conditions forecasted; and
Event venue location, amenities and overall expected quality of visitor experience.

The pricing algorithm of the present invention can be configured to account for variations in demand. The pricing algorithm calculates a value of an event ticket or a group of tickets (two or more) given a set of variables in real time. Those variables can include one or more of the following demand variables. Each of the following descriptions includes an indication as to whether they are preferably manually or automatically tracked or entered; however, alternative embodiments can include automatic or manual entry or tracking of any of these demand variables.

Event Client ID (CI)—An identification number for the name of a team, promoter, venue, or band. (Automated Generation)

Event ID (EI)—An identification number for a specific event. (Automated Generation)

Event Date (ED)—Calendar date of event (e.g. May 1, 2006 or 05-01-2006). (Manual Entry)

Event Time Zone (TZ)—Time zone of location where event is held. (Manual Entry)

Daylight Savings Time Applicability (DL)—Check for Daylight Savings Time applicability for data management of event start timers. (Manual Entry)

Event Starting Time (ES)—Event starting time in hours, minutes, and seconds (e.g. 02:00:00 PM). (Manual Entry)

Transfer Cutoff Time (TC)—hours, minutes, seconds prior to event starting time that Event Client has agreed to allocate available tickets to the trading system 100 (note: this is not the starting point of live ticket value trading). (Manual Entry)

Allocation (AL)—Number of tickets within a specific ticket category allocated to the trading system 100 by the Event Client for sale (e.g. 450 event tickets or “all unsold seats”). (Manual Entry)

Ticket Category (CG)—Ticket category or event client classification name for ticket inventory allocated to the trading system 100 (e.g. Club Box, Section 235). (Manual Entry)

Current Date (CD)—Current date in system clock/date. (Automated Tracking)

Current Time (CT)—Current time in system clock/date. (Automated Tracking)

Expected Length (EL)—Expected length of event in measurements of time based on historically researched data (e.g. 02:45:00 or two hours, 45 minutes and 0 seconds). (Manual Entry)

Expected Ending Time (ET)—Expected ending time of event based on Expected Length variable (e.g. May 1, 2006 04:45 PM). (Automated Tracking)

Trading Start Time (TS)—Starting time of live trading of allocated tickets. (Manual Entry)

Face Value (FV)—Face Value of the event ticket. (Manual Entry)

Start Limit (SL)—Fixed amount (absolute value) of discount, if any, at starting time of trading (e.g. $0.25 off of Face Value at trading start, or zero discount at trading start). (Manual Entry)

Starting Trade Amount (SA)—Based on the start limit and face value, the amount a ticket will trade for upon start of trading. (Automated Tracking)

Floor (FL)—Represented as a percentage of face value. This is the minimum percentage amount that tickets are allowed to trade down to as a percent of face value. (Manual Entry)

Floor Value (FA)—Based on the Floor variable, the resulting absolute value of the amount tickets are allowed to trade down to. (Automated Tracking)

Percent of Expected Length (PX)—Expressed as a percentage of Expected Length, this represents the percent of the expected length of event that trading will continue through and, most importantly, helps derive when trading will end. (Manual Entry)

PX Time Value (PV)—This is the absolute value of multiplying PX times EL expressed in hours, minutes and seconds. This amount of time can be added to event start time in order to calculate the trading end time. (Automated Tracking)

Trading End Time (TE)—The time resulting from adding the PV variable to the ST variable (event starting time). (Automated Tracking)

Increments of Decrease (ID)—This is the incremental amount of ticket value adjustment when a downward trading adjustment occurs. It is a fixed absolute value based on the following formula: [SA variable minus FA variable] divided by [(The difference in time between TS variable and TE variable) divided by (PI variable)]. (Automated Tracking)

Demand Flow Arrivals (DA)—Volume of site Arrivals. This measures the number of site arrivals to the website associated with the trading system 100 in the specific increment of time set by the PI variable (e.g. pace interval; in past 3 minutes) in order to anticipate an increase or decrease in potential interest in a range of events. (Automated Tracking)

Demand Flow Shops (DS)—Volume of shops of Specific Event. This measures the number of shops of a particular event on the website associated with the trading system 100 in a specific increment of time (e.g. in past 3 minutes) in order to measure the increase or decrease in demand for that event. (Automated Tracking)

Demand Flow Purchases (DP) Volume of purchases of tickets for the event in specific increments of time either prior to the event's beginning or the since the beginning of the event (e.g. 11 tickets sold in the past 90 seconds and the remaining time until the event starts is 23 minutes, 30 seconds; or 6 tickets sold in the past 120 seconds and the time that has past since the event's beginning is 10 minutes, 15 seconds). (Automated Tracking)

Site Arrival Adjustment Threshold (AT)—This is an absolute value defining at what level of site arrivals (DA) will support a hold, rather than decline, in ticket trading value as time progresses. In other words, if DA achieves the AT within the PI, price holds at its current level during that PI interval. This same measurement occurs again in the next interval to again assess whether price will be adjusted down or not, and so on. (Manual Entry)

Shops Adjustment Threshold (ST)—This is an absolute value defining at what level of shops (DS) support a hold, rather than decline, in ticket trading value as time progresses. In other words, if DS achieves the ST within the PI, price holds at its current level during that PI interval. This same measurement occurs again in the next interval to again assess whether price will be adjusted down or not, and so on. (Manual Entry)

Purchases Adjustment Threshold (PT)—This is an absolute value defining at what level of purchases (DP) support a hold, rather than decline, in ticket trading value as time progresses. In other words, if DP achieves the PT within the PI, price holds at its current level during that PI interval. This same measurement occurs again in the next interval to again assess whether price will be adjusted down or not, and so on. (Manual Entry)

Pace Interval (PI)—This is the specific increment of time used in combination with the DA, DS, DP variables and the AT, ST, PT variables respectively. During each pace interval (for example, set to 3 minutes), the DA, DS, DP variables will be checked against their respective AT, ST, PT variables near the end of each interval in order to determine whether the ticket price will be reduced by the ID variable at the completion (in time measurements) of that interval. It will function with the ability to set “bands” for the interval setting in order to further avoid predictability of trading changes (e.g. can be set to randomly move within a 3 minute to 5 minute band or other range). (Manual Entry)

Weather Index (WI)—This is scale variable (e.g. from 1 to 5) that is based on forecasted weather conditions for the period immediately prior to event start time (2 to 4 hours). In many cases, this index will be set to a neutral position of 3 which implies weather will have neither a positive nor negative impact on event attendance. (Manual Entry)

Additional and/or alternative demand variables can be used for adjusting ticket prices without departing from the spirit and scope of the present invention. Also, as mentioned above, circumstances of the event itself can be used to predict or determine demand for event tickets and adjust ticket prices. For example, if the event is a baseball game, the trading system can be configured to receive game statistics data about the baseball game before the game begins and/or while the baseball game is in progress. For example, the trading system can be in communication with a computer system that provides data about an injury to a key player, the current inning, the number of runs, hits, and errors. If the trading system detects that a no-hitter is in progress, the trading system can use this information determine whether ticket prices should be decreased at a slower rate, kept the same, or even increased.

Preferably, the pricing algorithm will generate a price result that is lower than the original face value of the ticket, but will depend on the actual values of one or more of the demand variables above or other variables that can be used without departing from the spirit and scope of the present invention. It is possible that tickets can sell at very small increments below face value if demand flow for that event is strong enough. Manual Entry variables can be managed individually based on each Event and Event Client relationship and can be contractually agreed to well in advance (typically, weeks or months) of actual Event starting time.

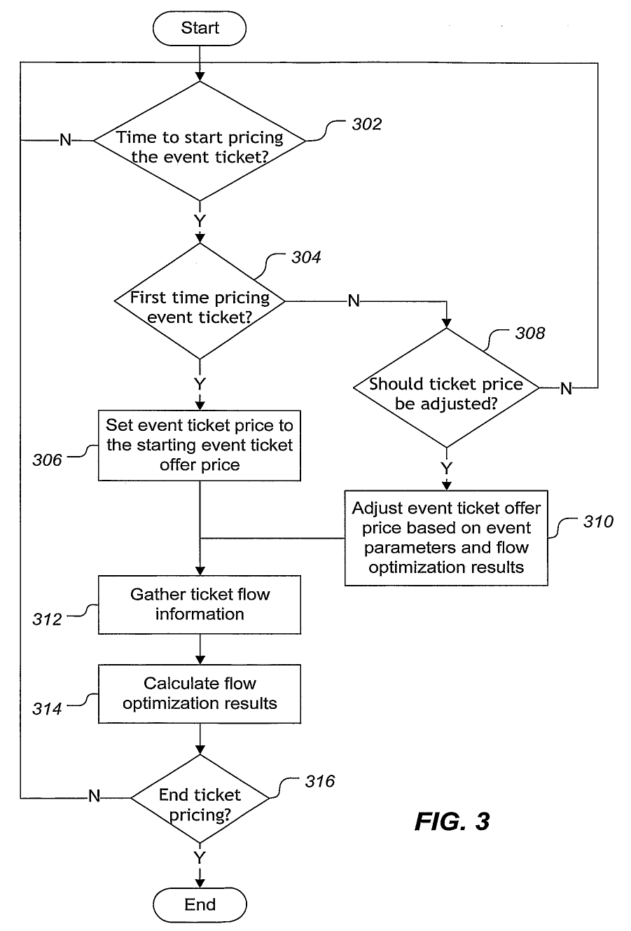

FIG. 3 shows a flowchart illustrating an embodiment of a pricing algorithm and process that can be performed by the trading system. In a preferred embodiment, this pricing algorithm and process is a computer-implemented process, e.g., performed according to instructions included in software. At step 302, the system determines whether it is time to start pricing the event tickets. During a first iteration of the process, this determination can include determining whether the time associated with TS has arrived. During second and subsequent iterations, step 302 can include determining whether an amount of time associated with the PI has elapsed.

Next, at step 304 the system determines whether this is the first time pricing the tickets for this event. If so, then at step 306 the ticket price is set to the starting event ticket offer price (e.g., the price associated with the Starting Trade Amount SA). Otherwise, at step 308 a determination is made as to whether the ticket price should be adjusted. This determination is preferably made based on time and ticket flow information (e.g., as determined at step 312).

If the ticket price should be adjusted, then at step 310 the ticket price is adjusted. In a preferred embodiment, the ticket price is adjusted according to demand variables, event parameters and flow optimization results (e.g., as determined at step 314). In some embodiments, the ticket price can be adjusted according to known price-adjustment methods. In some embodiments, one or more of the demand variables disclosed herein can be used in combination with known pricing methods in order to calculate a price adjustment. One or more mathematical and statistical equations can be deployed using a range of variables such as those described above to calculate an event ticket's value at a moment in time associated with the current iteration of this pricing process.

At step 312, the system gathers ticket flow information. This step can include gather information such as: (a) the number of tickets to the event that have been sold since the last price adjustment (e.g., at step 310); (b) the total number of tickets to the event that the system has sold; (c) the total number of tickets to the event that are left to sell; (d) the amount of time left that the event will be viable for selling tickets; and (e) a determination of an aggressiveness factor set for the event. The Aggressiveness Factor, similar to the Weather Index (or factor), is another index-based demand variable to allow an Event Client to place an additional (overarching other demand variables) limitation on how much and how fast ticket prices decrease (as driven by all other demand variables). For example, the trading price determined by the trading system using all other demand variables might be recommended to be 80% of face value at a given moment in time; continuing the example, assume an Aggressiveness Factor of 10 means the ticket will trade at a price unencumbered other than the other variables; continuing the example, if instead, the Aggressiveness Factor is set to something less than 10 (such as 1; super-conservative), the trading system would override its own recommendation to scale (based on the aggressiveness factor setting) the trading price to less of a discount (either linearly, logarithmically or other statistical approaches) than recommended, thereby reducing the aggressiveness from the initial recommendation.

At step 314, the system calculates flow optimization results. In a preferred embodiment, step 314 includes determining the effectiveness of the last price adjustment. This can include calculating an Effectiveness Factor. The Effectiveness Factor can be statistically derived automatically by the system by comparing a forecasted or expected demand of tickets to an actual demand of tickets on a continuous basis. The purpose of measuring the Effectiveness Factor is to determine how well the algorithm is performing in maximizing ticket sales (within its demand variable limitations). If the algorithm is not performing well (based on the quantitative result of the effectiveness factor), settings of demand variables can be recommended to be changed during trading or for later events and then actual sales and Effectiveness Factors measured again until the Effectiveness Factor improves and until no further improvement is attainable. The step 314 can also include estimating an expected Alpha for the next sales period, where the Alpha is a statistical measurement used to support the objectives of maximizing the Effectiveness Factor. The step 314 can further include estimating the ticket sales for a next sales period. The sales estimate can then be used to support the objectives of maximizing the Effectiveness Factor.

At step 316, the system checks whether ticket pricing should continue. This can include comparing current system time to the time associated with TE to determine whether it is time for trading to end for tickets to the present event. If so, the process ends. Otherwise, the process continues again from step 302.

Alternative methods of pricing can be implemented without departing from the spirit and scope of the present invention. For example, the trading system 100 can allow the Event Client to set a price path, which would control the rate of price decrease over time. For example, the trading system 100 can allow the event client to set a linear price path, a fixed price path, or a step-function price path.

### Example

An example of how the demand variables can be used to calculate a ticket price will now be discussed. Specific values used for this example in calculating ticket pricing according to the pricing algorithm are set forth in Table 1. These values are provided merely as examples; the specific exemplary values do not impose limitations on the present invention.

TABLE 1

| | | | MANUAL/ |
|---|---|---|---|
| VARI- | | | AUTO- |
| ABLE | EXAMPLE | DESCRIPTION | MATED |
| CI | 111654333 | ID number for Event Client; | AUTO- |
| | | linked to name of Team, | MATED |
| | | Promoter, or Venue | |
| EI | 111654333- | ID number for name of Event | AUTO- |
| | 10001 | | MATED |
| ED | Saturday, | Date of Event | MANUAL |
| | Jun. 03, | | |
| | 2006 | | |
| TZ | CST | The time zone of the Event | MANUAL |
| DL | Yes/No | Data entry allowing control of | MANUAL |
| | | whether event time zone | |
| | | requires daylight savings time | |
| | | tracking and control | |
| ES | 19:05:00 | Event starting time | MANUAL |
| TC | 0:50:00 | Hours, minutes, seconds prior | MANUAL |
| | | to start time that ticket | |
| | | allocation is confirmed | |
| AL | 500 | Maximum number of tickets | MANUAL |
| | | allowed to be sold through | |
| | | trading system if unsold at | |
| | | transfer cutoff; if unsold | |
| | | is less, then remaining amount | |
| | | is allocated | |
| CG | Club Box, | Ticket category; Event Client | MANUAL |
| | Section | classification name for ticket | |
| | 235 | tier | |
| CD | Saturday, | Current date at this time | AUTO- |
| | Jun. 03, | | MATED |
| | 2006 | | |
| CT | 18:30:00 | Current time in hours, minutes | AUTO- |
| | | and seconds | MATED |
| EL | 2:45:00 | Expected length of event, e.g. | MANUAL |
| | | based on historical data | |
| ET | 21:50:00 | Expected ending time of event | AUTO- |
| | | based on Expected Length | MATED |
| | | variable | |
| TS | 18:30:00 | Starting time of trading | MANUAL |
| FV | $50.00 | Face value of ticket in this | MANUAL |
| | | ticket category | |
| SL | $0.25 | Fixed amount (absolute value) | MANUAL |
| | | of discount at starting time | |
| | | of trading | |
| SA | $49.75 | Starting Trade Amount | AUTO- |
| | | | MATED |
| FL | 60.00% | Floor; percentage of face | MANUAL |
| | | value; this is the minimum | |
| | | percentage amount that tickets | |
| | | are allowed to go down | |
| | | to as a percent of face value | |
| FA | $30.00 | Floor's absolute Value | AUTO- |
| | | | MATED |
| PX | 40.00% | Percentage of Expected Length; | MANUAL |
| | | expressed as a percentage; the | |
| | | percent of the expected length | |
| | | of event that trading will | |
| | | continue through | |
| PV | 1:06:00 | The absolute value of PX after | AUTO- |
| | | multiplying PX by EL | MATED |
| TE | 20:11:00 | Trading end; based on PX; this | AUTO- |
| | | the result of PX multiplied by | MATED |
| | | EL and added to ES | |
| ID | $0.20 | This would be the amount of | AUTO- |
| | | reduction of each ticket in | MATED |
| | | each trading increments based | |
| | | on the formula [SA − FA] | |
| | | divided by [(difference in | |
| | | time between TS and TE) | |
| | | divided by (PI)] | |
| DA | 25 | Demand flow site arrivals | AUTO- |
| | | | MATED |
| DS | 10 | Demand flow shops | AUTO- |
| | | | MATED |
| DP | 5 | Demand flow purchases | AUTO- |
| | | | MATED |
| AT | 20 | Site arrival adjustment | MANUAL |
| | | threshold | |
| ST | 8 | Shops adjustment threshold | MANUAL |
| PT | 4 | Purchases adjustment threshold | MANUAL |
| PI | 0:01:00 | Pace Interval; can be set to | MANUAL |
| | | “bands” (e.g. 3 to 5 | |
| | | minutes where pace interval | |
| | | moves around randomly within | |
| | | that band) | |
| WI | 3 | Weather Index; if scale is 1 | MANUAL |
| | | to 5, 3 represents neutral | |
| | | position on weather's impact | |
| | | on attendance | |

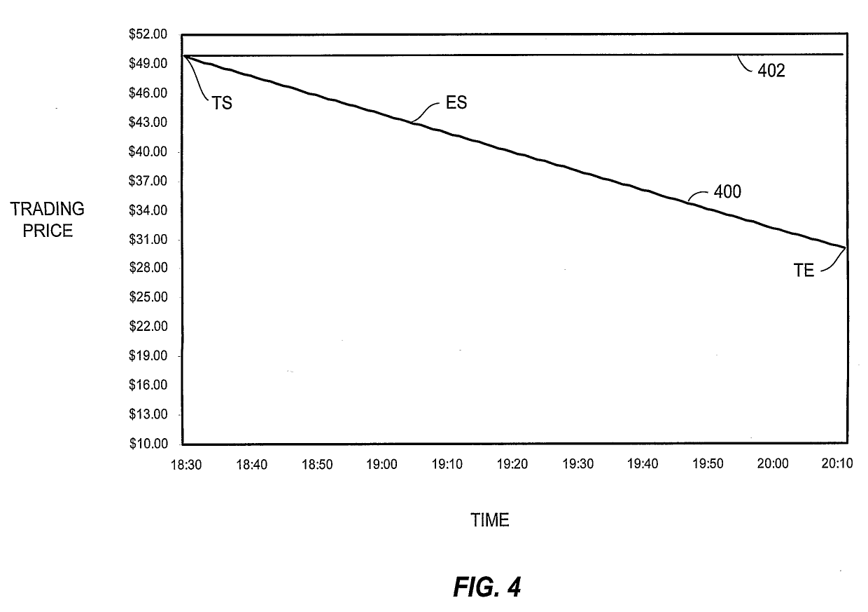

FIG. 4 shows a graph illustrating possible variations in ticket pricing over time according to the preferred algorithm using the exemplary values set forth in Table 1. Note that trading begins at TS=18:30:00. The event for which tickets are being sold begins at time ES=19:05:00. The trading ends at time TE=20:11:00. In this example, the time at which the trading is expected to end is based on a calculation involving PX, EL, and ST:

TE=(PX*EL)+ES (1)

where PX is the percent of the expected length of event that trading will continue through, EL is the expected length of the event, and ES is the event starting time. In FIG. 4, curve 400 illustrates a situation where the trading price is most heavily discounted during live trading (i.e., between times TS and TE), whereas curve 402 illustrates a situation where the trading price remains fixed during live trading. During actual trading, the price will be on or between lines 400 and 402, depending on Demand flow site arrivals (DA), Demand flow shops (DS), Demand flow purchases (DP), Site arrival adjustment threshold (AT), Shops adjustment threshold (ST), Purchases adjustment threshold (PT), and Pace Interval (PI).

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A computer-implemented trading system for facilitating the buying and selling of tickets to events, the system comprising one or more processors configured to:
receive a request from a user for availability information for a ticket to an event;
conduct a search of a database for an available ticket to the event; and
determine whether the ticket can be sold based on a rule for restricting ticket sales to a period of time that begins shortly before the beginning of the event and continues during the event.

2. The system of claim 1, wherein the event is selected from the group consisting of a sporting event, a concert event, a theater event, and a family-entertainment event.

3. The system of claim 1, wherein the rule for restricting ticket sales allows tickets to begin being offered for sale at a predetermined amount of time before the event is expected to begin.

4. The system of claim 3, wherein the predetermined amount of time is no more than seventy-two hours.

5. The system of claim 1, wherein the rule for restricting ticket sales allows tickets to begin being offered for sale until the event is expected to end.

6. The system of claim 1, wherein the one or more processors are further configured to calculate a price of the ticket based at least in part on at least one of (a) an amount of time until the event is expected to begin, (b) an amount of time that has elapsed since the beginning of the event, and (c) an amount of time remaining until the event is expected to end.

7. A computer-implemented method of facilitating the buying and selling of tickets to events, the method comprising:
receiving a request from a user for availability information for a ticket to an event;
conducting a search of a database for an available ticket to the event; and
determining whether the ticket can be sold based on a rule for restricting ticket sales to a period of time that begins shortly before the beginning of the event and continues during the event.

8. The method of claim 7, wherein the event is selected from the group consisting of a sporting event, a concert event, a theater event, and a family-entertainment event.

9. The method of claim 7, wherein the rule for restricting ticket sales allows tickets to begin being offered for sale at a predetermined amount of time before the event is expected to begin.

10. The method of claim 9, wherein the predetermined amount of time is no more than seventy-two hours.

11. The method of claim 7, wherein the rule for restricting ticket sales allows tickets to begin being offered for sale until the event is expected to end.

12. The method of claim 7, further comprising calculating a price of the ticket based at least in part on at least one of (a) an amount of time until the event is expected to begin, (b) an amount of time that has elapsed since the beginning of the event, and (c) an amount of time remaining until the event is expected to end.

13. A computer-implemented trading system for facilitating the buying and selling of tickets to events, the system comprising one or more processors configured to:
receive a request from a user for availability information for a ticket to an event;
conduct a search of a database for an available ticket to the event; and
calculate a price for the ticket based at least in part on a value of at least one demand variable, wherein the value of the demand variable is established during a period of time that begins shortly before the beginning of the event and continues during the event.

14. The system of claim 13, wherein the price for the ticket is based at least in part on an amount of time until the beginning of the event.

15. The system of claim 13, wherein the price for the ticket is based at least in part on an amount of time that has elapsed since the beginning of the event.

16. The system of claim 13, wherein the price for the ticket is based at least in part on an amount of time until the event is expected to end.

17. The system of claim 13, wherein the price for the ticket is based at least in part on weather conditions shortly before or during the event.

18. The system of claim 13, wherein the price for the ticket is based at least in part on a volume of inquiries concerning tickets for the event during a specified time increment that occurs shortly before or during the event.

19. The system of claim 13, wherein the price for the ticket is based at least in part on a volume of sales of tickets to the event during a specified time increment that occurs shortly before or during the event.

20. The system of claim 13, wherein the period of time during which the value of the demand variable is established begins no more than seventy-two hours before the event is expected to begin.

21. The system of claim 13, wherein the period of time during which the value of the demand variable is established ends when the event is expected to end.

22. A computer-implemented method for facilitating the buying and selling of tickets to events, the method comprising:
receiving a request from a user for availability information for a ticket to an event;
conducting a search of a database for an available ticket to the event; and
calculating a price for the ticket based at least in part on a value of at least one demand variable, wherein the value of the demand variable is established during a period of time that begins shortly before the beginning of the event and continues during the event.

23. The method of claim 22, wherein the price for the ticket is based at least in part on an amount of time until the beginning of the event.

24. The method of claim 22, wherein the price for the ticket is based at least in part on an amount of time that has elapsed since the beginning of the event.

25. The method of claim 22, wherein the price for the ticket is based at least in part on an amount of time until the event is expected to end.

26. The method of claim 22, wherein the price for the ticket is based at least in part on weather conditions shortly before or during the event.

27. The method of claim 22, wherein the price for the ticket is based at least in part on a volume of inquiries concerning tickets for the event during a specified time increment that occurs shortly before or during the event.

28. The method of claim 22, wherein the price for the ticket is based at least in part on a volume of sales of tickets to the event during a specified time increment that occurs shortly before or during the event.

29. The method of claim 22, wherein the period of time during which the value of the demand variable is established begins no more than seventy-two hours before the event is expected to begin.

30. The method of claim 22, wherein the period of time during which the value of the demand variable is established ends when the event is expected to end.

31. A method of valuing tickets to an event, the method comprising:
determining at least one of (a) an amount of time that has elapsed since the beginning of the event, and (b) an amount of time until the event is expected to end; and
decreasing a value of a ticket to the event based on the thus determined amount of time.

32. The method of claim 31, wherein the value of the ticket is incrementally decreased as the amount of time that has elapsed since the beginning of the event increases.

33. The method of claim 31, wherein the value of the ticket is incrementally decreased as the amount of time until the event is expected to end decreases.

34. The method of claim 31, wherein the decreasing of the value of the ticket is further based on at least one of (a) a volume of inquiries concerning tickets to the event during a specified time increment, and (b) a volume of sales of tickets to the event during a specified time increment.

35. The method of claim 31, wherein the decreasing of the value of the ticket is further based on weather conditions shortly before or during the event.

36. The method of claim 31, further comprising offering the tickets for sale on a website, wherein the decreasing of the value of the ticket is further based on at least one of (a) a volume of arrivals to the website during a specified time increment, (b) a volume of inquiries on the website concerning tickets to the event during a specified time increment, and (c) a volume of sales of tickets via the website to the event during a specified time increment.

37. A method of adjusting ticket prices for an event, the method comprising:
determining a price for a ticket to the event;
performing one or more iterations of a pricing process that includes:
determining the value of one or more demand variables;
determining whether to change the price of the ticket to the event based on the thus determined values; and
if it is determined that the price should change, adjusting the price of the ticket based at least in part on the value of the one or more demand variables.

38. A method according to claim 37, wherein the step of performing one or more iterations of a pricing process comprises performing a plurality of iterations of the pricing process over a period of time that begins and ends before the beginning of the event.

40. A method according to claim 37, wherein the step of performing one or more iterations of a pricing process comprises performing a plurality of iterations of the pricing process over a period of time that begins before the beginning of the event and ends during the event.

41. A method according to claim 37, wherein the step of performing one or more iterations of a pricing process comprises performing a plurality of iterations of the pricing process over a period of time that begins and ends during the event.
